(19) United States
(12) Patent Application Publication
(10) Pub. No.: US 2026/0016858 A1
(43) Pub. Date: Jan. 15, 2026

(54) DISPLAY DEVICE INCLUDING WINDOW AND METHOD OF MANUFACTURING WINDOW

(71) Applicant: Samsung Display Co., LTD., Yongin-si (KR)

(72) Inventors: JAE HOON JEONG, Yongin-si (KR); Seong Hwan KIM, Yongin-si (KR); Seongae JANG, Yongin-si (KR); MYUNG-HWAN KIM, Yongin-si (KR)

(21) Appl. No.: 19/209,340

(22) Filed: May 15, 2025

(30) Foreign Application Priority Data
Jul. 12, 2024 (KR) 10-2024-0092294

(51) Int. Cl. G06F 1/16

(52) U.S. Cl. CPC G06F 1/1656; G06F 1/1618

(57) ABSTRACT

A method of manufacturing a window includes providing a window assembly including a base substrate including a folding part and non-folding parts spaced apart from each other with the folding part interposed therebetween, a coating layer disposed on a first surface of the base substrate, and etching jigs overlapping the non-folding parts and arranged in the coating layer, immersing the folding part of the window assembly in an etchant, and exposing the folding part of the window assembly from the etchant, wherein second surfaces opposite to the first surface face each other in a folded state and are in direct contact with the etchant.

This application claims priority to Korean Patent Application No. 10-2024-0092294, filed on Jul. 12, 2024, and all the benefits accruing therefrom under 35 U.S.C. § 119, the content of which in its entirety is herein incorporated by reference.

### BACKGROUND

### 1. Field

The invention relates generally to a display device, and more particularly to a foldable display device and a method of manufacturing a window included in a foldable display device.

### 2. Description of Related Art

Various display devices such as televisions, mobile phones, tablet computers, and game consoles have been developed. In recent years, flexible display devices including slidable or foldable flexible display panels have been developed. Unlike rigid display devices, the flexible display devices may be folded, rolled, or bent. The flexible display devices having variously different shapes may be carried without being restricted by a screen size according to the related art, thereby improving user convenience. Windows included in the flexible display devices are required to have improved folding characteristics in folding areas.

### SUMMARY

Embodiments of the invention provide a display device having improved folding characteristics in a folding area, and a method of manufacturing a window.

According to an embodiment, a method of manufacturing a window includes providing a window assembly including a base substrate divided into a folding part folded about a folding axis extending in one direction and non-folding parts spaced apart from each other with the folding part interposed therebetween and including glass, a coating layer disposed on a first surface of the base substrate, and etching jigs overlapping the non-folding parts and arranged in the coating layer, immersing the folding part of the window assembly in an etchant, and exposing the folding part of the window assembly from the etchant, wherein second surfaces opposite to the first surface face each other in a folded state and are in direct contact with the etchant.

According to an embodiment, a display device includes a display module including a folding area folded about a folding axis extending in a first direction and non-folding areas spaced apart from each other in a second direction intersecting the first direction with the folding area interposed therebetween, and a window including a folding part overlapping the folding area and non-folding parts overlapping the non-folding areas and disposed on the display module, wherein the folding part includes a flat portion having a thickness smaller than a thickness of the non-folding parts and linear inclined portions arranged between the non-folding parts and the folding part and inclined at a predetermined angle, a thickness of each of the non-folding parts is in a range of about 50 μm to about 500 μm, a thickness of the flat portion is in a range of about 20 μm to about 100 μm, a width of the flat portion in the second direction is in a range of about 5 mm to about 50 mm, a width of each of the inclined portions is in a range of about 1 mm to about 20 mm, and in a state in which the folding part is unfolded, an angle between an extension line extending from the flat portion and the inclined portions is in a range of about 0.01 degrees to about 15 degrees. According to an embodiment, a display device includes a display module including a folding area folded about a folding axis extending in a first direction and non-folding areas spaced apart from each other in a second direction intersecting the first direction with the folding area interposed therebetween, and a window including a folding part overlapping the folding area and non-folding parts overlapping the non-folding areas and disposed on the display module, wherein the folding part includes a flat portion having a thickness smaller than a thickness of the non-folding parts and inclined portions each of which one end connected to the non-folding parts and the other end connected to the flat portion are curved at a predetermined curvature, a thickness of each of the non-folding parts is in a range of about 30 μm to about 400 μm, a thickness of the flat portion is in a range of about 10 μm to about 100 μm, a width of the flat portion in the second direction is in a range of about 5 mm to about 50 nm, a width of each of the inclined portions is in a range of about 1 mm to about 20 mm, and in a state in which the folding part is unfolded, an angle between an extension line extending from the flat portion and the inclined portions is in a range of about 0.01 degrees to about 15 degrees.

### BRIEF DESCRIPTION OF THE FIGURES

The above and other objects and features of the invention will become apparent by describing in detail embodiments thereof with reference to the accompanying drawings.

FIG. 1A is a perspective view illustrating a display device, according to an embodiment.

FIG. 1B is a perspective view illustrating the display device, according to an embodiment.

FIG. 1C is a perspective view illustrating the display device, according to an embodiment.

FIG. 1D is a perspective view illustrating the display device, according to an embodiment.

FIG. 2A is a perspective view illustrating the display device, according to an embodiment.

FIG. 2B is a perspective view illustrating the display device, according to an embodiment.

FIG. 2C is a perspective view illustrating the display device, according to an embodiment.

FIG. 3 is an exploded perspective view illustrating the display device, according to an embodiment.

FIG. 4 is a cross-sectional view illustrating a portion corresponding to line I-I′ of FIG. 3, according to an embodiment.

FIG. 5 is a plan view of a display panel, according to an embodiment.

FIG. 6 is a cross-sectional view of a window, according to an embodiment.

FIG. 7 is a cross-sectional view of a window, according to an embodiment.

FIG. 8 is a cross-sectional view of a window, according to an embodiment.

FIG. 9 is a cross-sectional view of a window, according to an embodiment.

FIG. 10 is a cross-sectional view of a window, according to an embodiment.

FIG. 11 is a cross-sectional view of a window assembly, according to an embodiment.

FIG. 12A is a cross-sectional view illustrating a method of manufacturing the window, according to an embodiment.

FIG. 12B is a cross-sectional view illustrating a method of manufacturing the window, according to an embodiment.

FIG. 13A is a cross-sectional view illustrating the method of manufacturing the window, according to an embodiment.

FIG. 13B is a cross-sectional view illustrating the method of manufacturing the window, according to an embodiment.

### DETAILED DESCRIPTION

In the specification, the expression that a first component (or area, layer, part, portion, etc.) is “disposed on”, “connected with” or “coupled to” a second component means that the first component is directly disposed on/connected with/coupled to the second component or means that a third component is interposed therebetween.

The same reference numerals refer to the same components. Further, in the drawings, the thickness, the ratio, and the dimension of components are exaggerated for effective description of technical contents. The expression “and/or” includes one or more combinations which associated components are capable of defining.

Although the terms “first”, “second”, etc. may be used to describe various components, the components should not be limited by the terms. The terms are only used to distinguish one component from another component. For example, without departing from the right scope of the present disclosure, a first component may be referred to as a second component, and similarly, the second component may be also referred to as the first component. Singular expressions include plural expressions unless clearly otherwise indicated in the context.

Also, the terms “under”, “below”, “on”, “above”, etc. are used to describe the correlation of components illustrated in drawings. The terms that are relative in concept are described based on a direction illustrated in drawings.

It will be understood that the terms “include”, “comprise”, “have”, etc. specify the presence of features, numbers, steps, operations, elements, or components, described in the specification, or a combination thereof, and do not exclude in advance the presence or additional possibility of one or more other features, numbers, steps, operations, elements, or components or a combination thereof.

Unless otherwise defined, all terms (including technical terms and scientific terms) used in the specification have the same meaning as commonly understood by those skilled in the art to which the invention belongs. Further, terms such as terms defined in the dictionaries commonly used should be interpreted as having a meaning consistent with the meaning in the context of the related technology and should not be interpreted in overly ideal or overly formal meanings unless explicitly defined herein.

Hereinafter, an embodiment will be described with reference to the accompanying drawings.

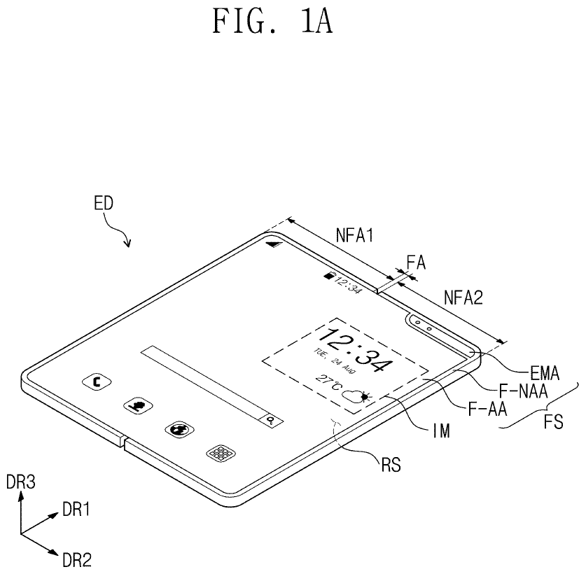

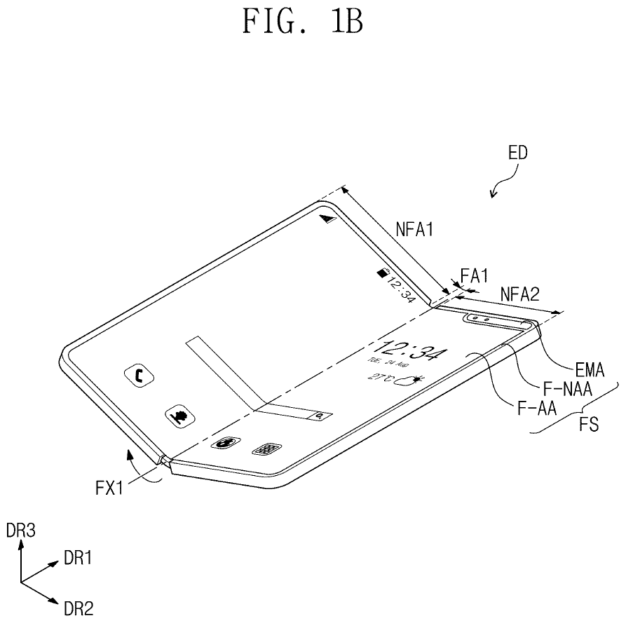

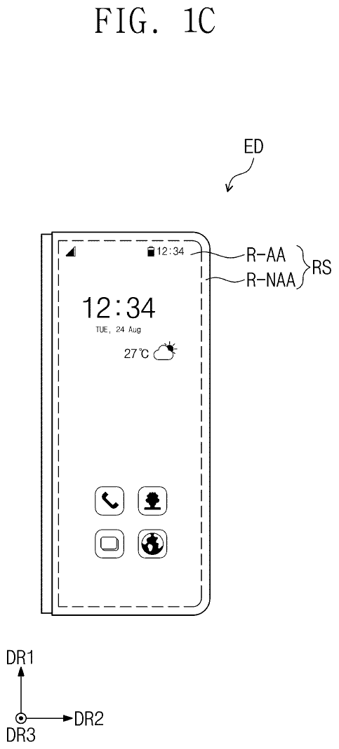

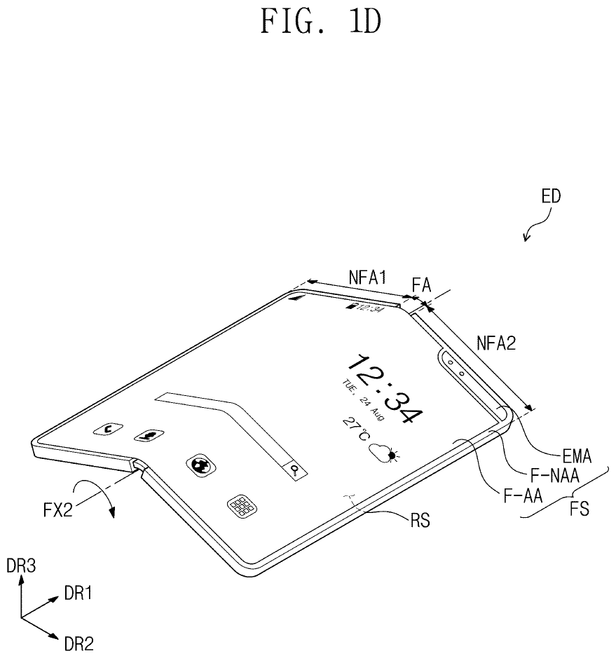

FIG. 1A is a perspective view illustrating a display device, according to an embodiment. FIG. 1B is a perspective view illustrating the display device, according to an embodiment. FIG. 1C is a perspective view illustrating the display device, according to an embodiment. FIG. 1D is a perspective view illustrating the display device, according to an embodiment.

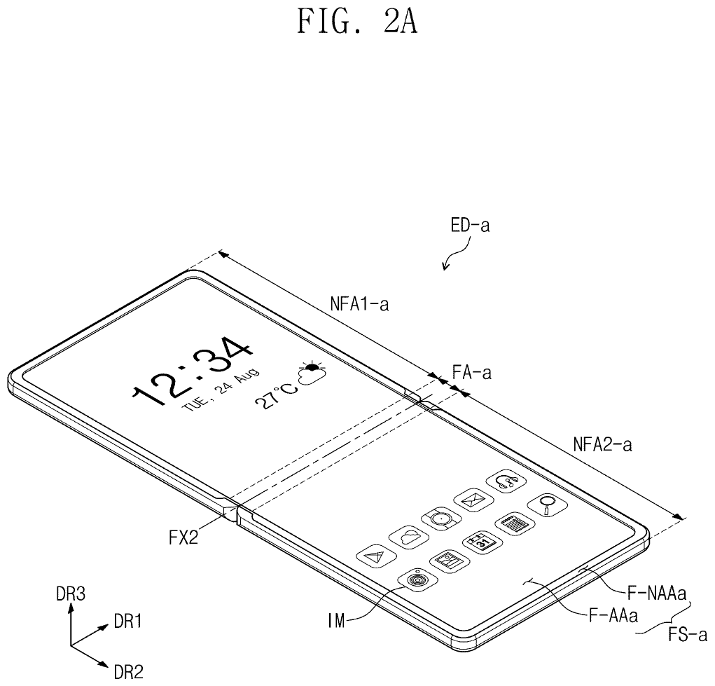

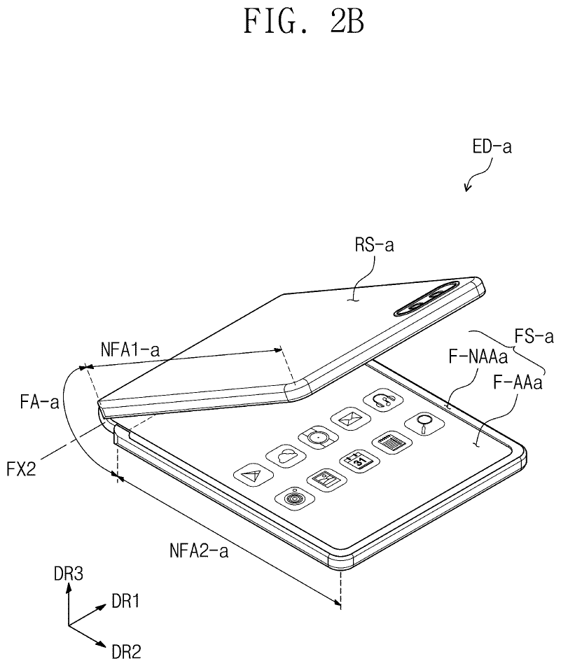

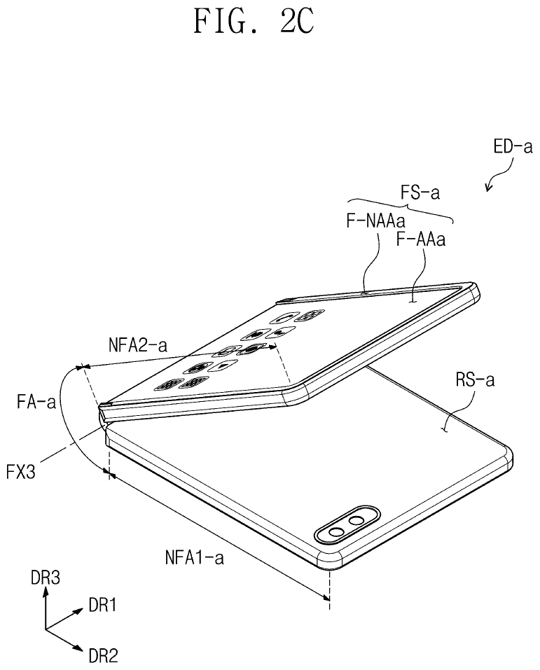

FIG. 1A is a perspective view of a state in which a display device ED, according to an embodiment, is unfolded. The display device ED, according to an embodiment, may be a device that is activated by an electrical signal. For example, the display device ED may be a mobile phone, a tablet computer, a vehicle navigation system, a game console, or a wearable device, but the invention is not limited thereto. FIGS. 1A to 2C illustratively illustrate a foldable display device ED or ED-a, where the foldable display device ED or ED-a, according to an embodiment, may be a mobile phone.

In an embodiment, the display device ED may include a first display surface FS defined by a first direction DR1 and a second direction DR2 intersecting the first direction DR1. The display device ED may provide an image IM to a user through the first display surface FS. The display device ED may display the image IM toward a third direction DR3 with the first display surface FS parallel to each of the first direction DR1 and the second direction DR2.

In the specification, the first direction DR1 and the second direction DR2 are perpendicular to each other, and the third direction DR3 may be a normal direction to a plane defined by the first direction DR1 and the second direction DR2. A thickness direction of the display device ED may be a direction parallel to the third direction DR3. A front surface (or an upper surface) and a rear surface (or a lower surface) may be opposite to each other in the third direction DR3, and a normal direction of each of the front surface (or the upper surface) and the rear surface (or the lower surface) may be parallel to the third direction DR3. The front surface (or the upper surface) means a surface close to the first display surface FS, and the rear surface (or the lower surface) means a surface spaced apart from the first display surface FS. Further, the rear surface (or the lower surface) means a surface close to a second display surface RS, which will be described below. An upper side (or an upper portion) means a direction closer to the first display surface FS, and a lower side (or a lower portion) means a direction away from the first display surface FS.

A cross section of components means a surface directed parallel to the third direction DR3, and a plane thereof means a surface perpendicular to the third direction DR3 that is the thickness direction. A plane means a surface defined by the first direction DR1 and the second direction DR2.

In an embodiment, the display device ED may sense an external input applied from the outside. The external input may include various types of inputs provided from the outside of the display device ED. For example, the external input may include a contact by a part of a body of a user such as a hand and an external input (for example, hovering) applied close to the display device ED or disposed adjacent to the display device ED at a predetermined distance. Further, the external input may have various forms such as a force, a pressure, a temperature, and a light.

In an embodiment, the display device ED may include the first display surface FS and the second display surface RS. The first display surface FS may include a first active area F-AA, a first peripheral area F-NAA, and an electronic module area EMA. The second display surface RS may be defined as a surface facing at least a portion of the first display surface FS. That is, the second display surface RS may be defined as a portion of the rear surface of the display device ED.

The first active area F-AA may be an area that is activated according to an electrical signal. The first active area F-AA may be an area in which the image IM is displayed and various forms of external inputs may be sensed.

The first peripheral area F-NAA may be an area in which the image IM is not displayed. The first peripheral area F-NAA may be disposed adjacent to the first active area F-AA. The first peripheral area F-NAA may have a predetermined color. The first peripheral area F-NAA may surround the first active area F-AA. Accordingly, the shape of the first active area F-AA may be defined substantially by the first peripheral area F-NAA. However, this is illustrative, and the first peripheral area F-NAA may be disposed adjacent to only one side of the first active area F-AA or may be omitted.

In an embodiment, various electronic modules may be arranged in the electronic module area EMA. For example, the electronic module may include at least one of a camera, a speaker, a light sensing sensor, and a heat sensing sensor. The electronic module area EMA may sense an external subject received through the display surfaces FS and RS or provide a sound signal such as voice to the outside through the display surfaces FS and RS. The electronic module may include a plurality of components, and the invention is not limited to these embodiments.

In an embodiment, the electronic module area EMA may be surrounded by the first peripheral area F-NAA. However, this is illustrative, and the invention is not limited to an embodiment. For example, the electronic module area EMA may be surrounded by the first active area F-AA and the first peripheral area F-NAA, and the electronic module area EMA may be disposed inside the first active area F-AA.

The display device ED, according to an embodiment, may be divided into at least one folding area FA and a plurality of non-folding areas NFA1 and NFA2 extending from the folding area FA. For example, the first non-folding area NFA1, the folding area FA, and the second non-folding area NFA2 may be defined in the second direction DR2. The display device ED may be divided into the first non-folding area NFA1 and the second non-folding area NFA2 and spaced apart from each other in the second direction DR2 with the folding area FA therebetween. For example, the first non-folding area NFA1 may be disposed on one side of the folding area FA in the second direction DR2, and the second non-folding area NFA2 may be disposed on the other side of the folding area FA in the second direction DR2.

FIG. 1A illustrates the display device ED including the one folding area FA, according to an embodiment, but the invention is not limited thereto, and a plurality of folding areas may be defined in the display device ED. For example, the display device, according to an embodiment, may include two or more folding areas and may include three or more non-folding areas arranged with the folding areas interposed therebetween.

FIG. 1B is a perspective view illustrating a folding operation of the display device ED, according to an embodiment. FIG. 1C is a plan view of a state in which the display device ED, according to an embodiment, is folded. FIG. 1D is a perspective view illustrating a folding operation of the display device ED, according to an embodiment.

Referring to FIG. 1B, the display device ED, according to an embodiment, may be folded about a first folding axis FX1 extending in the first direction DR1. In a state in which the display device ED is folded, the folding area FA may have a predetermined curvature and a predetermined radius of curvature. The display device ED may be folded about the first folding axis FX1 so that the first non-folding area NFA1 and the second non-folding area NFA2 face each other and may be changed into an in-folding state so that the first display surface FS is not exposed to the outside.

Referring to FIG. 1C, in a state in which the display device ED, according to an embodiment, is in an in-folding state, the second display surface RS may be visually recognized by a user. In this case, the second display surface RS may include a second active area R-AA that displays an image. The second active area R-AA may be an area that is activated according to an electrical signal. The second active area R-AA may be an area on which an image is displayed, and various types of external inputs may be sensed.

Further, the second display surface RS may include a second peripheral area R-NAA. The second peripheral area R-NAA may be adjacent to the second active area R-AA. The second peripheral area R-NAA may have a predetermined color. The second peripheral area R-NAA may surround the second active area R-AA. Further, although not illustrated, the display device ED may further include an electronic module area in which an electronic module including various components is disposed on the second display surface RS, but the invention is not limited to an embodiment.

According to an embodiment, in a state in which the display device ED is in the in-folding state, a distance between the first non-folding area NFA1 and the second non-folding area NFA2 may be smaller than a radius of a circle defined by the radius of curvature of the folding area FA. In this case, the folding area FA may be folded into a dumbbell shape, and the distance between the first non-folding area NFA1 and the second non-folding area NFA2 may be decreased. Thus, the slimmer display device ED may be provided in a folding state.

Referring to FIG. 1D, the display device ED, according to an embodiment, may be folded about a second folding axis FX2 extending in the first direction DR1. The display device ED may be folded about the second folding axis FX2 and changed into an out-folding state so that the first display surface FS is exposed to the outside. In an embodiment, the display device ED may be configured to mutually repeat an in-folding operation or an out-folding operation from an unfolding operation, but the invention is not limited thereto.

Although FIGS. 1A to 1D illustratively illustrate the folding about the one folding axis FX1 or FX2, the number of folding axes and the number of non-folding areas according thereto are not limited thereto. For example, the display device ED may be folded about a plurality of folding axes so that the first display surface FS and the second display surface RS are folded to partially face each other. Further, it is illustrated that the first folding axis FX1 and the second folding axis FX2 are parallel to long sides of the display device ED, but the invention is not limited thereto, and the first folding axis FX1 and the second folding axis FX2 may be parallel to short sides of the display device ED.

In an embodiment of the display device ED, as illustrated in FIG. 1C, the first non-folding area NFA1 and the second non-folding area NFA2 may be defined as portions having the display surfaces FS and RS parallel to the plane defined by the first direction DR1 and the second direction DR2 in a folding state, and the folding area FA may be defined as an area between the first non-folding area NFA1 and the second non-folding area NFA2. The folding area FA may include a curved surface that is curved to have a predetermined curvature in a folding state.

FIG. 2A is a perspective view illustrating the display device, according to an embodiment. FIG. 2B is a perspective view illustrating the display device, according to an embodiment. FIG. 2C is a perspective view illustrating the display device, according to an embodiment.

FIGS. 2A to 2C are perspective views illustrating the display device ED-a, according to an embodiment. FIG. 2A is a perspective view illustrating an unfolded state of the display device ED-a, according to an embodiment. FIGS. 2B and 2C are perspective views illustrating an folding operation of the display device ED-a, according to an embodiment. FIG. 2B is a perspective view illustrating an in-folding operation of the display device ED-a illustrated in FIG. 2A, according to an embodiment. FIG. 2C is a perspective view illustrating an out-folding operation of the display device ED-a illustrated in FIG. 2A, according to an embodiment.

Referring to FIG. 2A, the display device ED-a may be folded about a third folding axis FX3 extending in the first direction DR1. An extension direction of the third folding axis FX3 may be parallel to an extension direction of short sides of the display device ED-a.

The display device ED-a may be divided into a folding area FA-a, a first non-folding area NFA1-a adjacent to one side of the folding area FA-a, and a second non-folding area NFA2-a adjacent to the other side of the folding area FA-a. The first non-folding area NFA1-a and the second non-folding area NFA2-a may be spaced apart from each other with the folding area FA-a interposed therebetween.

The folding area FA-a may be an area folded about the third folding axis FX3. In a state in which the display device ED-a is folded, the folding area FA-a may have a predetermined curvature and a predetermined radius of curvature. The first non-folding area NFA1-a and the second non-folding area NFA2-a may face each other, and the display device ED-a may be in-folded so that the display surface FS-a is not exposed to the outside.

Referring to FIG. 2A, in an embodiment, in a state in which the display device ED-a is in an unfolded state (i.e., a non-folded state) such that a display surface FS-a is visually recognized by the user. As described with reference to FIGS. 1A to 1D, the display surface FS-a of the display device ED-a may include an active area F-AAa and a peripheral area F-NAAa. The active area F-AAa may be an area in which the image IM is displayed, and various forms of external inputs may be sensed.

Referring to FIG. 2B, in a state in which the display device ED-a, according to an embodiment, is in-folded, a rear surface RS-a may be visually recognized by the user. For example, the rear surface RS-a may function as a second display surface that displays a video or an image. Further, the electronic module area in which the electronic module including various components is disposed may be disposed on the rear surface RS-a. According to an embodiment, the rear surface RS-a of the display device ED-a may further include an active area in which an image is displayed.

In an embodiment and referring to FIG. 2C, the display device ED-a may be folded about the third folding axis FX3 and changed into an out-folding state in which one area of the rear surface RS-a overlapping with the first non-folding area NFA1-a and the other area of the rear surface RS-a overlapping the second non-folding area NFA2-a face each other.

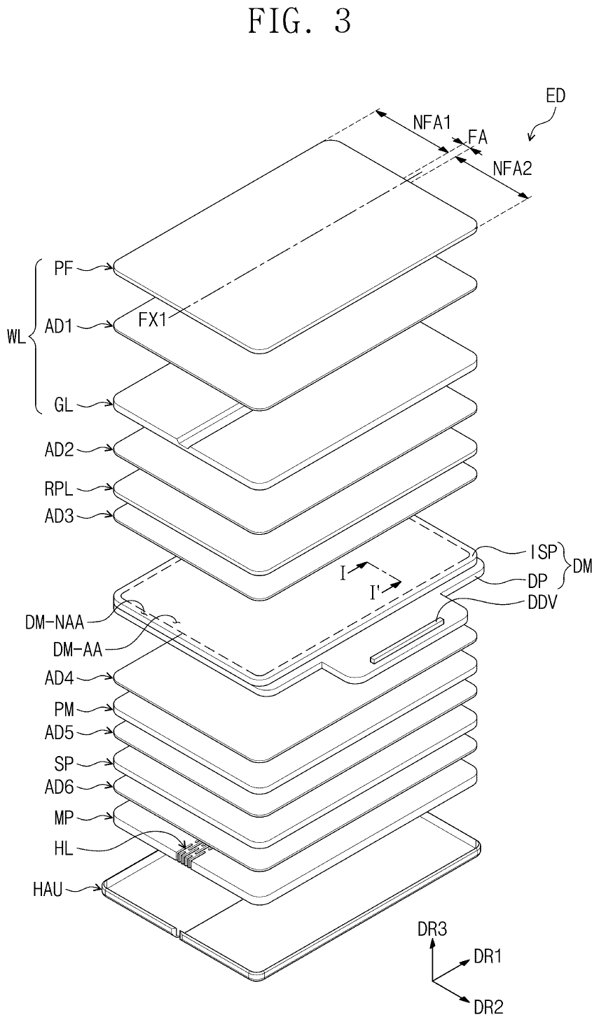

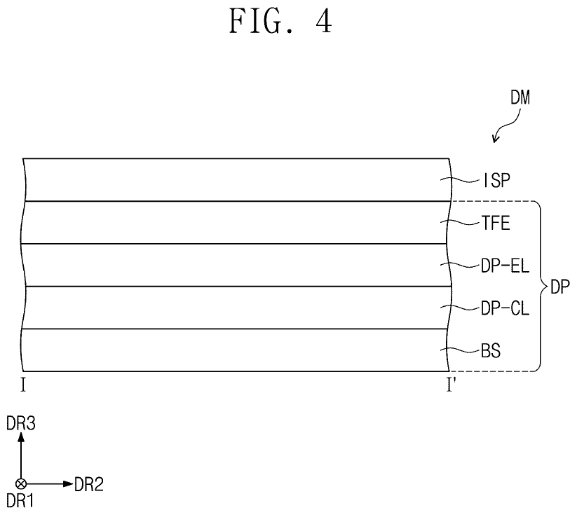

FIG. 3 is an exploded perspective view illustrating the display device, according to an embodiment. FIG. 4 is a cross-sectional view illustrating a portion corresponding to line I-I′ of FIG. 3, according to an embodiment. FIG. 5 is a plan view of a display panel, according to an embodiment. Hereinafter, features described in the display device ED may be applied to the display device ED-a described in FIGS. 2A to 2C.

In an embodiment and referring to FIG. 3, the display device ED may include a window WL, a display module DM, an optical layer RPL, a lower film PM, a support plate SP, a lower plate MP, and a housing HAU.

The housing HAU may be coupled to the window WL and define an exterior of the display device ED. The housing HAU may include a material having a relatively high rigidity. For example, the housing HAU may include a plurality of frames and/or support plates made of glass, plastic, or metal. The housing HAU may provide a predetermined accommodation space. The display module DM may be accommodated inside the accommodation space and protected from an external impact. According to an embodiment, the housing HAU overlapping the folding area FA may further include a hinge structure or the like for guiding the folding operation of the display device ED.

In an embodiment, the display module DM may be disposed under the optical layer RPL. The display module DM may be activated by an electrical signal. The display module DM may be activated to display the image IM (FIG. 1A) in the first active area F-AA (FIG. 1A) of the display device ED. A display area DM-AA and a non-display area DM-NAA may be defined in the display module DM. The display area DM-AA may be an area that is activated according to an electrical signal. The non-display area DM-NAA may be an area positioned adjacent to at least one side of the display area DM-AA. A circuit, a wiring line, or the like for driving the display area DM-AA may be disposed in the non-display area DM-NAA.

In an embodiment, the optical layer RPL may be disposed between the display module DM and the window WL. The optical layer RPL may be a reflection preventing layer that reduces reflectance of an external light input from the outside of the display module DM. The optical layer RPL may be formed on the display module DM through a continuous process. The optical layer RPL may include a polarizing plate or a color filter layer. For example, the optical layer RPL may include at least one of a retarder, a polarizer, a polarizing film, and a polarizing filter. Unlike this, the optical layer RPL may include a plurality of color filters arranged in a predetermined array and a black matrix adjacent to the color filters.

In an embodiment, the image IM (see FIG. 1A) generated in the display module DM may be provided to the user through the window WL. The window WL may include a polymer substrate or a glass substrate.

The window WL, according to an embodiment, may include a protective layer PF and a base substrate GL including a glass. The protective layer PF and the base substrate GL may include an optically transparent insulating material.

The protective layer PF may be disposed on the base substrate GL. The protective layer PF may be a functional layer that protects an upper surface of the base substrate GL. The protective layer PF may include a polymer film.

The base substrate GL, according to an embodiment, may have a shape of which a portion overlapping the folding area FA is recessed. The recessed portion may have a shape of which a portion is removed from a front surface of the base substrate GL in the third direction DR3 that is the thickness direction. Thus, a thickness of the base substrate GL in the folding area FA may be smaller than a thickness of the base substrate GL in the non-folding areas NFA1 and NFA2. The recessed portion may be formed by an etching process. According to an embodiment, the window WL having improved folding characteristics may be provided.

The protective layer PF may include a fingerprint preventing coating agent, a hard coating agent, a static preventing agent, or the like. According to an embodiment, a coating layer may be further included between a first adhesive layer AD1 and the base substrate GL, and a description thereof will be made below.

In an embodiment, the lower film PM may protect a lower portion of a display panel DP. The lower film PM may include a flexible plastic material. For example, the lower film PM may include polyethylene terephthalate.

The support plate SP may be disposed under the display panel DP. A portion of the support plate SP, according to an embodiment, may be bent to absorb an impact applied between components arranged on the support plate SP and the housing HAU. Further, the support plate SP may prevent foreign substances or the like from being introduced into the components arranged on the support plate SP.

The lower plate MP may be disposed under the support plate SP. The lower plate MP may include a plurality of holes HL overlapping the folding area and passing through the lower plate MP to facilitate the folding operation of the display device ED. The lower plate MP may include a metal material. For example, the lower plate MP may include any one of aluminum (Al) or molybdenum (Mo). However, the invention is not limited thereto, and the lower plate MP may include a matrix including a filler and woven fiber lines arranged inside the matrix. The fiber lines may be arranged in a woven form inside the matrix.

The fiber lines may include a reinforced fiber composite. The reinforced fiber composite may be any one of carbon fiber-reinforced plastic (CFRP) or glass fiber-reinforced plastic (GFRP). A diameter of one fiber included in one fiber line may be in a range of about 3 μm or more and about 10 μm or less.

The matrix, according to an embodiment, may include at least one of epoxy, polyester, polyamide, polycarbonate, polypropylene, polybutylene, and vinyl ester.

The matrix may include the filler. The filler may include at least one of silica, barium sulphate, sintered talc, barium titanate, titanium oxide, clay, alumina, mica, boehmite, zinc borate, and zinc stannate.

The display device ED, according to an embodiment, may further include at least one of a cushion layer and a shielding layer. The cushion layer may prevent the lower plate MP from being pressed or plastically deformed due to an external impact and force. The cushion layer may include an elastomer such as sponge, foam, or urethane resin. Further, the cushion layer may be formed to include at least one of an acryl-based polymer, a urethane-based polymer, a silicone-based polymer, and an imide-based polymer. The shielding layer may be an electromagnetic shielding layer or a heat dissipating layer.

The display device ED, according to an embodiment, may further include first to sixth adhesive layers AD1 to AD6, respectively. The first adhesive layer AD1 may be disposed between the base substrate GL and the protective layer PF. The second adhesive layer AD2 may be disposed between the optical layer RPL and the base substrate GL. The third adhesive layer AD3 may be placed between the display module DM and the optical layer RPL. The fourth adhesive layer AD4 may be disposed between the lower film PM and the display module DM. The fifth adhesive layer AD5 may be disposed between the support plate SP and the lower film PM. The sixth adhesive layer AD6 may be disposed between the lower plate MP and the support plate SP.

Each of the adhesive layers AD1 to AD6 and adhesive layers which will be described below may include a conventional adhesive such as a pressure sensitive adhesive (PSA), an optically clear adhesive (OCA), or an optical clear resin (OCR), but the invention is not limited to an embodiment. In the display device ED, according to an embodiment, at least one of the adhesive layers AD1 to AD6 may be omitted.

In an embodiment and referring to FIG. 4, the display module DM may include the display panel DP and an input sensing layer ISP disposed on the display panel DP. The display panel DP may be a component that substantially generates an image. The display panel DP may be a light emitting display panel. For example, the display panel DP may be an organic light emitting display panel, an inorganic light emitting display panel, a micro light emitting diode (LED) display panel, a micro OLED display panel, or a nano LED display panel.

In an embodiment, the display panel DP may include a base layer BS, a circuit layer DP-CL, a display element layer DP-EL, and an encapsulation layer TFE that are sequentially laminated. Unlike the illustration, a functional layer may be further disposed between two adjacent layers among the base layer BS, the circuit layer DP-CL, the display element layer DP-EL, and the encapsulation layer TFE.

The base layer BS may provide a base surface on which the circuit layer DP-CL is disposed. The base layer BS may be a flexible substrate that may be bent, folded, and rolled. The base layer BS may be a glass substrate, a metal substrate, a polymer substrate, or the like. However, the invention is not limited thereto, and the base layer BS may include an inorganic layer, an organic layer, or a composite material layer.

In an embodiment, the base layer BS may include a single layer or a plurality of layers. For example, the base layer BS may include a first synthetic resin layer, a multi-layer or single-layer inorganic layer, and a second synthetic resin layer disposed on the multi-layer or single-layer inorganic layer. Each of the first synthetic resin layer and the second synthetic resin layer may include a polyimide-based resin. Further, each of the first synthetic resin layer and the second synthetic resin layer may include at least one of an acryl-based resin, a methacryl-based resin, a polyisoprene-based resin, a vinyl-based resin, an epoxy-based resin, a urethane-based resin, a cellulose-based resin, a siloxane-based resin, a polyamide-based resin, and a perylene-based resin. In the specification, a “˜˜-based” resin means a resin including a functional group of “˜˜.”

The circuit layer DP-CL may be disposed on the base layer BS. The circuit layer DP-CL may include an insulating layer, a semiconductor pattern, a conductive pattern, a signal line, and the like. The display element layer DP-EL may be disposed on the circuit layer DP-CL. The display element layer DP-EL may include a light emitting element (not illustrated). For example, the light emitting element may include an organic light emitting material, an inorganic light emitting material, an organic-inorganic light emitting material, a quantum dot, a quantum rod, a micro LED, or a nano LED.

The encapsulation layer TFE may be disposed on the display element layer DP-EL. The encapsulation layer TFE may protect the display element layer DP-EL from foreign substances such as moisture, oxygen, and dust particles. The encapsulation layer TFE may include at least one inorganic layer. For example, the encapsulation layer TFE may include an inorganic layer, an organic layer, and an inorganic layer which are sequentially laminated.

In an embodiment, the input sensing layer ISP may be disposed on the display panel DP. The input sensing layer ISP may be directly disposed on the encapsulation layer TFE. Unlike this, an adhesive member may be disposed between the input sensing layer ISP and the display panel DP.

In the specification, the fact that a first component is directly disposed on a second component means that a third component is not disposed between the first component and the second component. That is, the fact that a first component is “directly disposed” on a second component means that the first component and the second component are “in contact with” each other.

In an embodiment, the input sensing layer ISP may sense an external input, change the sensed external input into a predetermined input signal, and provide the input signal to the display panel DP. For example, the input sensing layer ISP may be a touch sensing layer that senses touch. The input sensing layer ISP may recognize a direct touch of the user, an indirect touch of the user, a direct touch of an object, or an indirect touch of the object.

The input sensing layer ISP may sense at least one of a position and a strength (pressure) of a touch applied from the outside. The input sensing layer ISP may have various structures or be formed of various materials, and the invention is not limited to an embodiment. For example, the input sensing layer ISP may sense an external input in a capacitive manner. The display panel DP may receive the input signal from the input sensing layer ISP and generate an image corresponding to the input signal.

In an embodiment and referring to FIG. 5, the display panel DP may include pixels PX, a scan driver SDV, a data driver DDV, and an emission driver EDV.

The display panel DP may include a first area AA1, a second area AA2, and a bending area BA between the first area AA1 and the second area AA2. The bending area BA may extend along the first direction DR1, and the first area AA1, the bending area BA, and the second area AA2 may be arranged in the second direction DR2. The bending area BA may be bent such that the second area AA2 overlaps a lower surface of the first area AA1 along a bending axis extending in the first direction DR1. According to an embodiment, a width of the bending area BA and the second area AA2 in the first direction DR1 may be smaller than a width of the first area AA1 in the first direction DR1. Accordingly, the bending area BA may be easily bent to the lower surface of the first area AA1.

In an embodiment, the first area AA1 may include a display area DA and a non-display area NDA around the display area DA. The non-display area NDA may surround the display area DA. The display area DA may be an area that displays an image, and the non-display area NDA may be an area that does not display an image. The second area AA2 and the bending area BA may be areas that do not display images.

In an embodiment, the first area AA1 may include the first non-folding area NFA1, the second non-folding area NFA2, and the folding area FA between the first non-folding area NFA1 and the second non-folding area NFA2, which are arranged in the second direction DR2. The first non-folding area NFA1, the second non-folding area NFA2, and the folding area FA may correspond to the first non-folding area NFA1, the second non-folding area NFA2, and the folding area FA of the display device ED illustrated in FIG. 1A.

In an embodiment, the first area AA1 may be bent and folded about the above-described folding axes. For example, the folding area FA of the first area AA1 may be folded about the above-described folding axes, and thus the display panel DP may be folded.

In an embodiment, the display panel DP may include the plurality of pixels PX, a plurality of scan lines SLI to SLm, a plurality of data lines DL1 to DLn, a plurality of light emitting lines EL1 to ELm, a first control line CSL1, a second control line CSL2, a power line PL, a plurality of connection lines CNL, and a plurality of pads PD. “m” and “n” are natural numbers. The pixels PX may be arranged in the display area DA and connected to the scan lines SLI to SLm, the data lines DL1 to DLn, and the light emitting lines EL1 to ELm.

In an embodiment, the scan driver SDV and the emission driver EDV may be arranged in the non-display area NDA. The scan driver SDV and the emission driver EDV may be arranged in the non-display area NDA disposed adjacent to both sides of the first area AA1, which are opposite to each other in the first direction DR1. The data driver DDV may be disposed in the second area AA2. The data driver DDV may be manufactured in the form of an integrated circuit chip and mounted on the second area AA2.

In an embodiment, the scan lines SLI to SLm may extend in the first direction DRland may be connected to the scan driver SDV. The data lines DL1 to DLn may extend in the second direction DR2 and may be connected to the data driver DDV via the bending area BA. The data driver DDV may be connected to the pixels PX through the data lines DL1 to DLn. The light emitting lines EL1 to ELm may extend in the second direction DR2 and may be connected to the emission driver EDV.

In an embodiment, the power line PL may extend in the second direction DR2 and may be disposed in the non-display area NDA. The power line PL may be disposed between the display area DA and the emission driver EDV. The power line PL may extend to the second area AA2 via the bending area BA. The power line PL may extend toward a lower end of the second area AA2 when viewed on a plane. The power line PL may receive a driving voltage.

In an embodiment, the connection lines CNL may extend in the first direction and may be arranged in the DR 1 second direction DR2. The connection lines CNL may be connected to the power line PL and the pixels PX. The driving voltage may be applied to the pixels PX through the power line PL and the connection lines CNL connected to each other.

In an embodiment, the first control line CSL1 may be connected to the scan driver SDV and may extend toward a lower end of the second area AA2 via the bending area BA. The second control line CSL2 may be connected to the emission driver EDV and may extend toward the lower end of the second area AA2 via the bending area BA. The data driver DDV may be disposed between the first control line CSL1 and the second control line CSL2.

In an embodiment, when viewed on a plane, the pads PD may be arranged adjacent to the lower end of the second area AA2. The data driver DDV, the power line PL, the first control line CSL1, and the second control line CSL2 may be connected to the pads PD.

In an embodiment, the data lines DL1 to DLn may be connected to the corresponding pads PD through the data driver DDV. For example, the data lines DL1 to DLn may be connected to the data driver DDV, and the data driver DDV may be connected to the pads PD respectively corresponding to the data lines DL1 to DLn.

Although not illustrated, In an embodiment, a printed circuit board may be connected to the pads PD, and a timing controller and a voltage generator may be arranged on the printed circuit board. The timing controller may be manufactured as an integrated circuit chip and mounted on the printed circuit board. The timing controller and the voltage generator may be connected to the pads PD through the printed circuit board.

In an embodiment, the timing controller may control operations of the scan driver SDV, the data driver DDV, and the emission driver EDV. The timing controller may generate a scan control signal, a data control signal, and a light emitting control signal in response to control signals received from an external unit. The voltage generator may generate a driving voltage.

In an embodiment, the scan control signal may be provided to the scan driver SDV through the first control line CSL1. The light emitting control signal may be provided to the emission driver EDV through the second control line CSL2. The data control signal may be provided to the data driver DDV. The timing controller may receive image signals from an external unit, convert data formats of the image signals to satisfy interface specifications with the data driver DDV, and provide the converted image signals to the data driver DDV.

In an embodiment, the scan driver SDV may generate a plurality of scan signals in response to the scan control signal. The scan signals may be applied to the pixels PX through the scan lines SLI to SLm. The scan signals may be sequentially applied to the pixels PX.

In an embodiment, the data driver DDV may generate a plurality of data voltages corresponding to the image signals in response to the data control signal. The data voltages may be applied to the pixels PX through the data lines DL1 to DLn. The emission driver EDV may generate a plurality of light emitting signals in response to the light emitting control signal. The light emitting signals may be applied to the pixels PX through the light emitting lines EL1 to ELm.

In an embodiment, the pixels PX may receive the data voltages in response to the scan signals. The pixels PX may display an image by emitting lights having luminances corresponding to the data voltages in response to the light emitting signals. Light emitting times of the pixels PX may be controlled by the light emitting signals. Each of the pixels PX may include transistors, a capacitor, and light emitting elements connected thereto. Each of the transistors may include a semiconductor pattern. The semiconductor pattern may include polysilicon, amorphous silicon, or a metal oxide. The semiconductor pattern may be doped with an N-type dopant or a P-type dopant. The semiconductor pattern may include a high-doped area and a low-doped area. The high-doped area may have conductivity that is greater than that of the low-doped area and may substantially serve as a source electrode and a drain electrode of the transistor. The low-doped area may substantially correspond to an active area (or a channel) of the transistor.

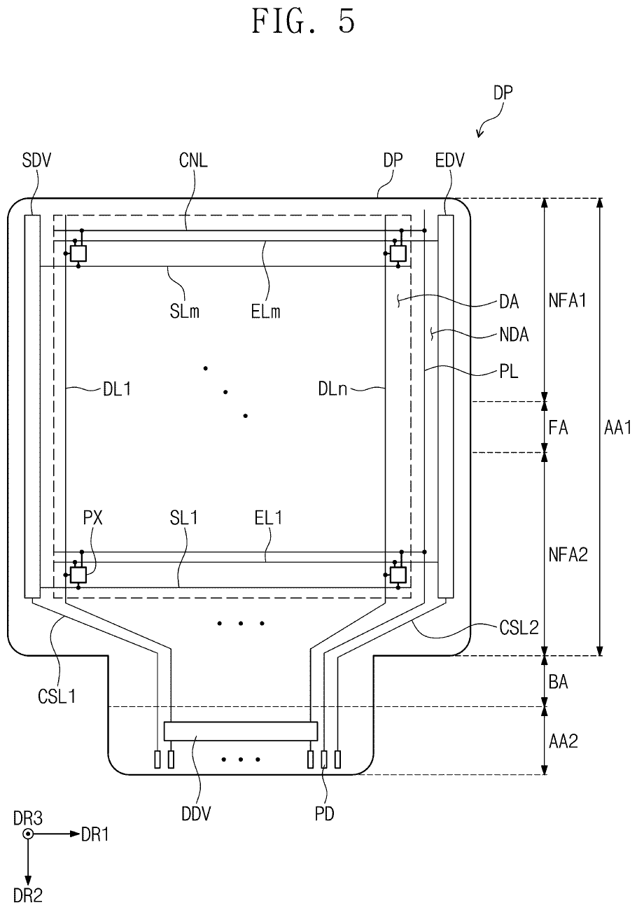

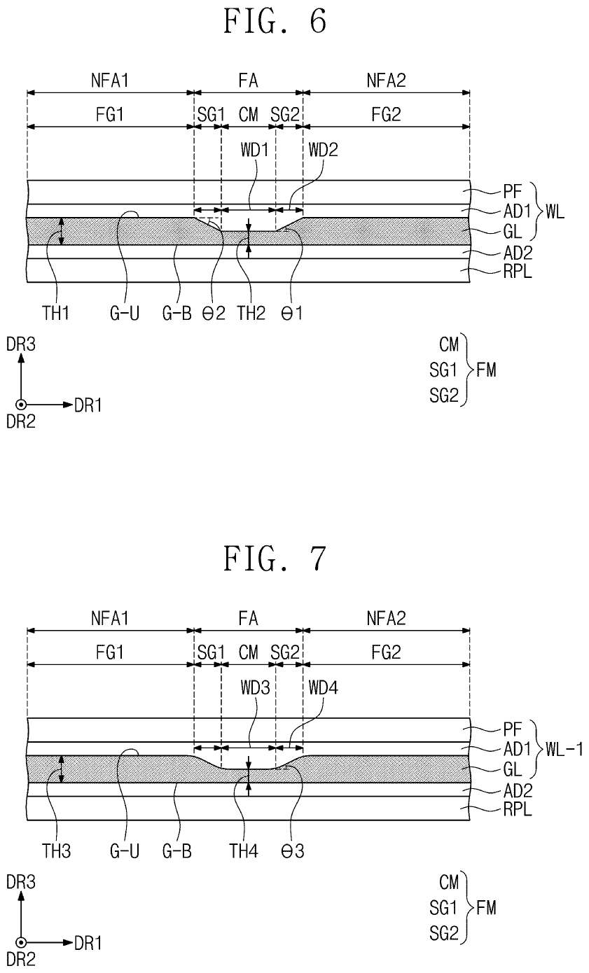

FIGS. 6 to 10 are cross-sectional views of a window, according to an embodiment. An embodiment of the window, which will be described in FIGS. 6 to 10, may be applied to the display device ED or ED-a described in FIGS. 1A to 2C. FIGS. 6 to 10 illustrate only the window, the first adhesive layer AD1, the second adhesive layer AD2, the optical layer RPL disposed under the window among the components included in the above-described display device, and the other components described in FIG. 3 are omitted. Further, a duplicated description will be omitted.

Referring to FIG. 6, the display device, according to an embodiment, may include the window WL and the optical layer RPL disposed under the window WL. The window WL and the optical layer RPL may be coupled by the second adhesive layer AD2.

The window WL, according to an embodiment, may include the protective layer PF and the base substrate GL. The protective layer PF and the base substrate GL may be coupled by the first adhesive layer AD1. According to an embodiment, an upper surface G-U (second surface in claim) of the base substrate GL may be in contact with the first adhesive layer AD1, and a lower surface G-B (first surface in claim) of the base substrate GL may be in contact with the second adhesive layer AD2. The upper surfaces G-U (second surfaces in the claim) of the base substrate GL may face each other in an in-folded state.

In an embodiment, the base substrate GL may include a first non-folding part FG1 overlapping the first non-folding area NFA1, a second non-folding part FG2 overlapping the second non-folding area NFA2, and a folding part FM overlapping the folding area FA. In a state in which the base substrate GL is unfolded, the first non-folding part FG1 and the second non-folding part FG2 may be spaced apart from each other in the first direction DR1 with the folding part FM interposed therebetween.

In an embodiment, the folding part FM may include an area recessed in a direction from the protective layer PF to the base substrate GL. According to an embodiment, the folding part FM may include a flat portion CM, a first inclined portion SG1, and a second inclined portion SG2.

In an embodiment, the first inclined portion SG1 may extend from the first non-folding part FG1 and may be connected to one end of the flat portion CM. The second inclined portion SG2 may extend from the second non-folding part FG2 and may be connected to the other end of the flat portion CM.

In an embodiment, on a cross section, the first inclined portion SG1 and the second inclined portion SG2 may be inclined at a predetermined angle. For example, the first inclined portion SG1 may extend from the first non-folding part FG1 to the flat portion CM, and in a state in which the base substrate GL is unfolded, the first inclined portion SG1 may be inclined downward from the first non-folding part FG1 toward the flat portion CM.

In an embodiment, the second inclined portion SG2 may extend from the second non-folding part FG2 to the flat portion CM, and in a state in which the base substrate GL is unfolded, the second inclined portion SG2 may be inclined downward from the second non-folding part FG2 toward the flat portion CM.

According to an embodiment, in a state in which the base substrate GL is unfolded, the first inclined portion SG1 and the second inclined portion SG2 may have a linear shape.

According to an embodiment in which the first inclined portion SG1 and the second inclined portion SG2 have a linear shape, a first thickness TH1 of the first non-folding part FG1 and the second non-folding part FG2 may be greater than a second thickness TH2 of the flat portion CM. For example, the first thickness TH1 may be in a range of about 50 μm to about 500 μm. The second thickness TH2 may be in a range of about 20 μm to about 100 μm.

In an embodiment and in a state in which the base substrate GL is unfolded, a first width WD1 of the flat portion CM in the first direction DR1 may be greater than a second width WD2 of each of the first inclined portion SG1 and the second inclined portion SG2. For example, the first width WD1 may be in a range of about 5 mm to about 50 mm. The second width WD2 may be in a range of about 1 mm to about 20 mm.

According to an embodiment, a first angle Θ1 between an imaginary line extending in the first direction DR1 along the flat portion CM and the first inclined portion SG1 and the second inclined portion SG2 may be in a range of about 0.01 degree to about 15 degrees. A second angle Θ2 between an imaginary line extending in the first direction DR1 along the first non-folding part FG1 and the second non-folding part FG2 and the first inclined portion SG1 and the second inclined portion SG2 may be equal to or gentler than the first angle Θ1.

According to an embodiment, as a portion of the base substrate GL includes the recessed folding part FM in a portion overlapping the folding area FA, a defect in which cracks occur in an area of the window WL overlapping the folding area FA may be prevented when the display device is folded. Accordingly, the display device having improved durability and reliability may be provided.

Referring to FIG. 7, the display device, according to an embodiment, may include a window WL-1 and the optical layer RPL disposed under the window WL-1. The window WL-1 and the optical layer RPL may be coupled by the second adhesive layer AD2. A difference from the window WL described in FIG. 6 will be mainly described.

The window WL-1, according to an embodiment, may include the protective layer PF and the base substrate GL. The base substrate GL may include the first non-folding part FG1 overlapping the first non-folding area NFA1, the second non-folding part FG2 overlapping the second non-folding area NFA2, and the folding part FM overlapping the folding area FA.

In an embodiment, the folding part FM may include the area recessed in a direction from the protective layer PF to the base substrate GL. According to an embodiment, the folding part FM may include the flat portion CM, the first inclined portion SG1, and the second inclined portion SG2.

On a cross section, the first inclined portion SG1 and the second inclined portion SG2 may be inclined at a predetermined angle. For example, the first inclined portion SG1 may extend from the first non-folding part FG1 to the flat portion CM, and in a state in which the base substrate GL is unfolded, the first inclined portion SG1 may be inclined downward from the first non-folding part FG1 toward the flat portion CM.

In an embodiment, the second inclined portion SG2 may extend from the second non-folding part FG2 to the flat portion CM, and in a state in which the base substrate GL is unfolded, the second inclined portion SG2 may be inclined downward from the second non-folding part FG2 toward the flat portion CM.

According to an embodiment, in a state in which the base substrate GL is unfolded, one end and the other end of each of the first inclined portion SG1 and the second inclined portion SG2 may have a predetermined curvature.

According to an embodiment in which the one end and the other end of each of the first inclined portion SG1 and the second inclined portion SG2 have a curved shape, a third thickness TH3 of the first non-folding part FG1 and the second non-folding part FG2 may be greater than a fourth thickness TH4 of the flat portion CM. For example, the third thickness TH3 may be in a range of about 30 μm to about 400 μm. The fourth thickness TH4 may be in a range of about 10 μm to about 100 μm.

In a state in which the base substrate GL is unfolded, a third width WD3 of the flat portion CM in the first direction DR1 may be greater than a fourth width WD4 of each of the first inclined portion SG1 and the second inclined portion SG2. For example, the third width WD3 may be in a range of about 5 mm to about 50 mm. The fourth width WD4 may be in a range of about 1 mm to about 20 mm.

According to an embodiment, a third angle Θ3 between the imaginary line extending in the first direction DR1 along the flat portion CM and the first inclined portion SG1 and the second inclined portion SG2 may be in a range of about 0.01 degree to about 15 degrees.

According to an embodiment, as the portion of the base substrate GL includes the recessed folding part FM in a portion overlapping the folding area FA, a defect in which cracks occur in an area of the window WL-1 overlapping the folding area FA may be prevented when the display device is folded. Accordingly, the display device having improved durability and reliability may be provided.

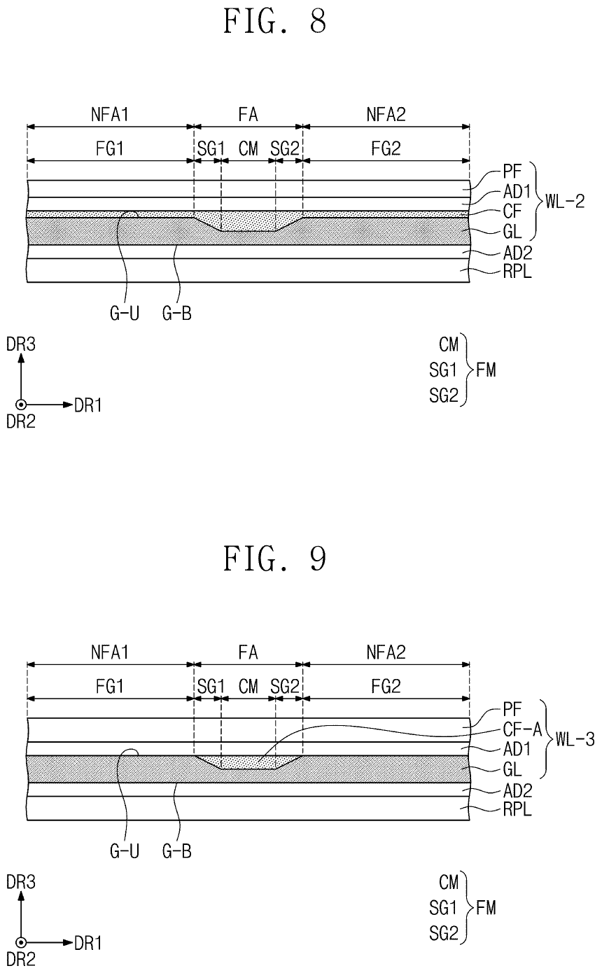

Referring to FIG. 8, the display device, according to an embodiment, may include a window WL-2 and the optical layer RPL disposed under the window WL-2. The window WL-2 and the optical layer RPL may be coupled by the second adhesive layer AD2. A difference from the windows WL and WL-1 described in FIGS. 6 and 7 will be mainly described.

The window WL-2, according to an embodiment, may include the protective layer PF, the base substrate GL, and a coating layer CF. The protective layer PF and the coating layer CF may be coupled by the first adhesive layer AD1. The coating layer CF may include resin. According to an embodiment, the coating layer CF may be disposed on the upper surface G-U (second surface in claim) of the base substrate GL. The lower surface G-B (first surface in claim) of the base substrate GL may be in contact with the second adhesive layer AD2.

In an embodiment, the base substrate GL may include the first non-folding part FG1 overlapping the first non-folding area NFA1, the second non-folding part FG2 overlapping the second non-folding area NFA2, and the folding part FM overlapping the folding area FA.

The folding part FM may include the area recessed in a direction from the protective layer PF to the base substrate GL. According to an embodiment, the folding part FM may include the flat portion CM, the first inclined portion SG1, and the second inclined portion SG2.

According to an embodiment, the coating layer CF may extend to the first non-folding part FG1, the folding part FM, and the second non-folding part FG2. Thus, the coating layer CF may be disposed on the base substrate GL to provide a flat surface. Accordingly, a step generated in a process of removing a portion of the folding part FM to improve folding characteristics of the base substrate GL may be covered by the flat portion CM. Accordingly, defects in which the shape of the folding part FM is visually recognized from the outside may be prevented.

According to an embodiment, a thickness of the coating layer CF disposed on the first non-folding part FG1 and the second non-folding part FG2 may be in a range of about 0.1 μm to about 30 μm.

Referring to FIG. 9, the display device, according to an embodiment, may include a window WL-3 and the optical layer RPL disposed under the window WL-3. The window WL-3 and the optical layer RPL may be coupled by the second adhesive layer AD2. A difference from the windows WL, WL-1, and WL-2 described in FIGS. 6 to 8 will be mainly described.

The window WL-3, according to an embodiment, may include the protective layer PF, the base substrate GL, and a coating layer CF-A. The protective layer PF and the coating layer CF-A may be coupled by the first adhesive layer AD1. The coating layer CF-A may include resin.

In an embodiment, the base substrate GL may include the first non-folding part FG1 overlapping the first non-folding area NFA1, the second non-folding part FG2 overlapping the second non-folding area NFA2, and the folding part FM overlapping the folding area FA.

In an embodiment, the folding part FM may include the area recessed in a direction from the protective layer PF to the base substrate GL. According to an embodiment, the folding part FM may include the flat portion CM, the first inclined portion SG1, and the second inclined portion SG2.

According to an embodiment, the coating layer CF-A may be disposed on an upper surface of the folding part FM, and upper surfaces of the first non-folding part FG1 and the second non-folding part FG2 may be exposed from the coating layer CF-A. Thus, the first adhesive layer AD1 may be in contact with the first non-folding part FG1 and the second non-folding part FG2 in the first non-folding area NFA1 and the second non-folding area NFA2 and may be in contact with the folding part FM in the folding area FA.

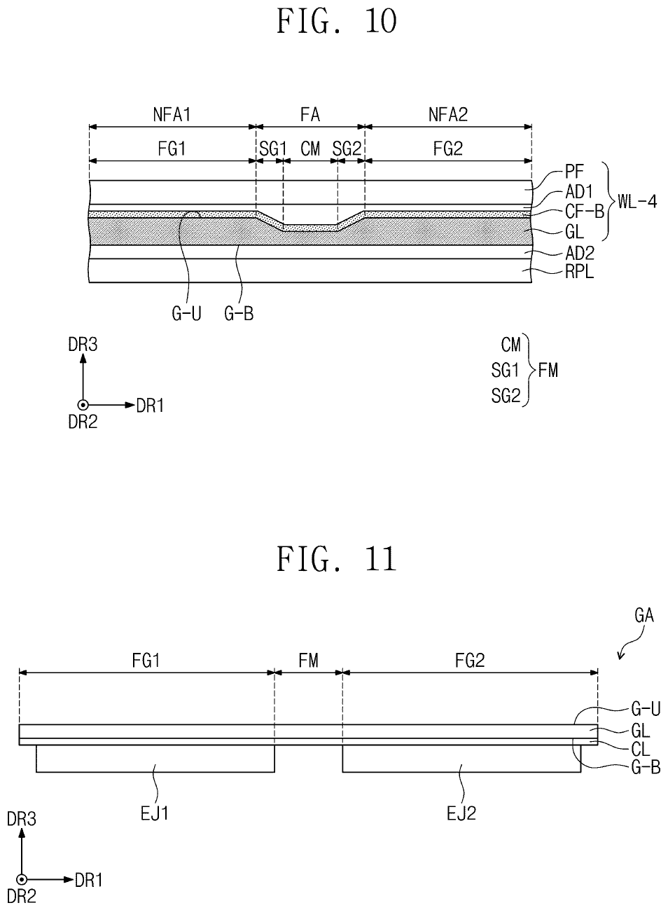

Referring to FIG. 10, the display device, according to an embodiment, may include a window WL-4 and the optical layer RPL disposed under the window WL-4. The window WL-4 and the optical layer RPL may be coupled by the second adhesive layer AD2. A difference from the windows WL, WL-1, and WL-2 described in FIGS. 6 to 8 will be mainly described.

The window WL-4, according to an embodiment, may include the protective layer PF, the base substrate GL, and a coating layer CF-B. The protective layer PF and the coating layer CF-B may be coupled by the first adhesive layer AD1. The coating layer CF-B may include resin.

In an embodiment, the base substrate GL may include the first non-folding part FG1 overlapping the first non-folding area NFA1, the second non-folding part FG2 overlapping the second non-folding area NFA2, and the folding part FM overlapping the folding area FA.

In an embodiment, the folding part FM may include the area recessed in a direction from the protective layer PF to the base substrate GL. According to an embodiment, the folding part FM may include the flat portion CM, the first inclined portion SG1, and the second inclined portion SG2.

According to an embodiment, the coating layer CF-B may be disposed on the upper surface of the base substrate GL. In an embodiment, the coating layer CF-B may cover the upper surface of the base substrate GL to correspond to a shape of a step formed between the folding part FM and the first non-folding part FG1 and the second non-folding part FG2. Thus, in an embodiment, the coating layer CF-B may have a shape corresponding to a shape of the upper surface of the base substrate GL.

According to an embodiment, a thickness of the coating layer CF-B may be in a range of about 0.1 μm to about 30 μm.

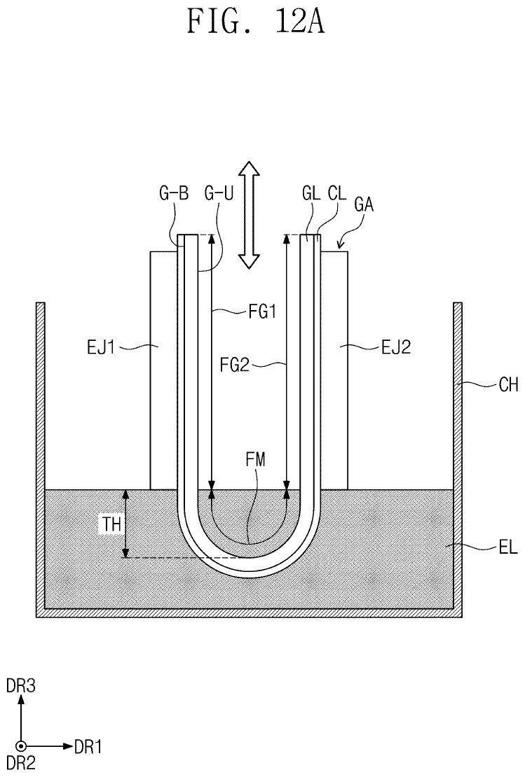

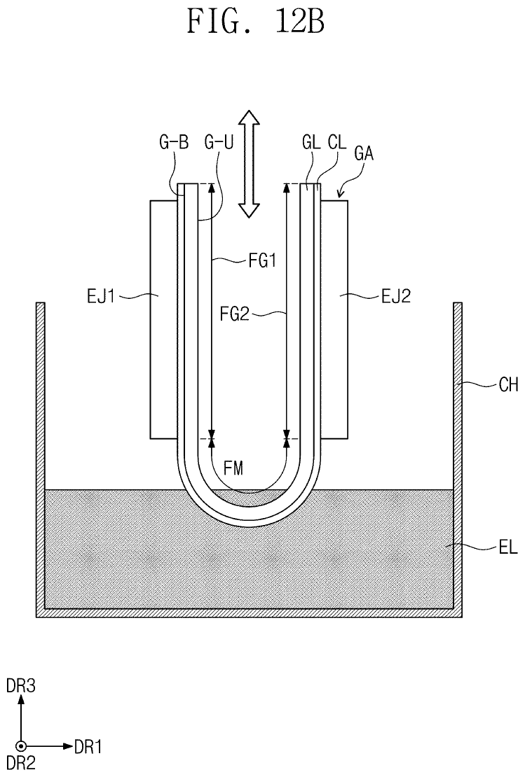

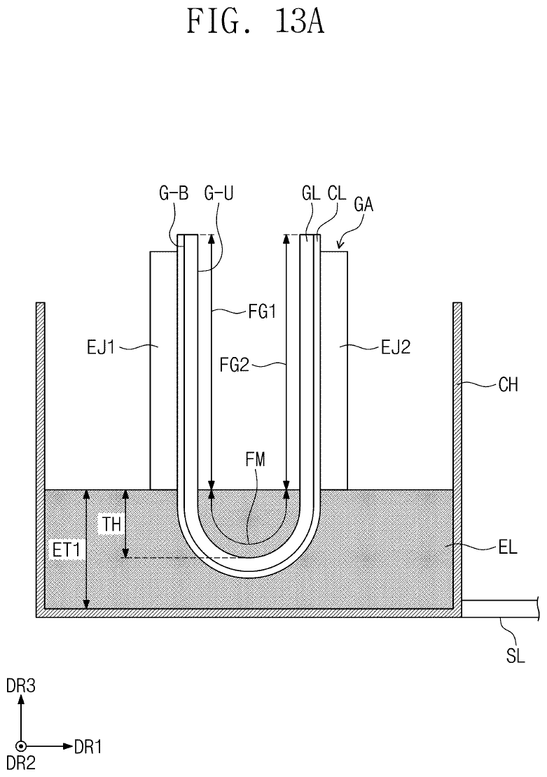

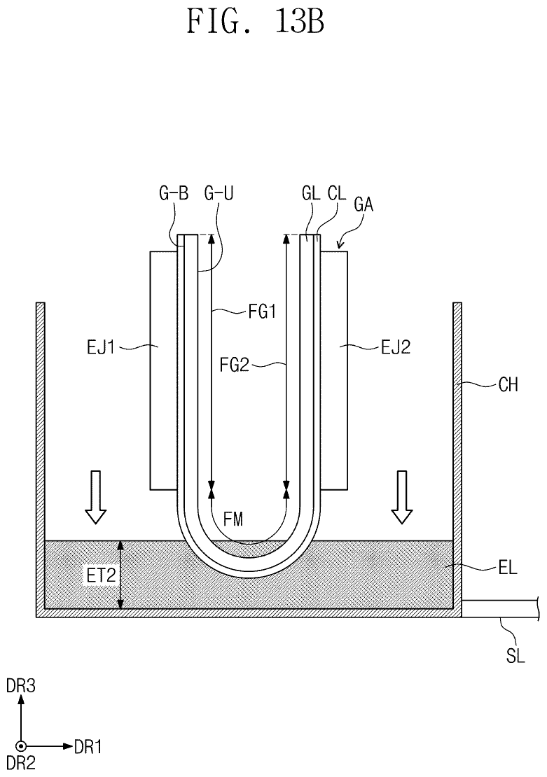

FIG. 11 is a cross-sectional view of a window assembly, according to an embodiment. FIGS. 12A and 12B are cross-sectional views illustrating a method of manufacturing the window, according to an embodiment. FIGS. 13A and 13B are cross-sectional views illustrating the method of manufacturing the window, according to an embodiment. Hereinafter, a method of manufacturing the windows WL and WL-1 described in FIGS. 6 and 7 will be described with reference to FIGS. 11 to 13B.

In an embodiment and referring to FIG. 11, a window assembly GA used in the method of manufacturing the window may include the base substrate GL, a film layer CL, a first etching jig EJ1, and a second etching jig EJ2. The base substrate GL may include the upper surface G-U (second surface in claim) and the lower surface G-B (first surface in claim) which are opposite to each other in the third direction DR3.

In an embodiment, the base substrate GL may include the first non-folding part FG1 overlapping the first non-folding area NFA1 (see FIG. 6), the second non-folding part FG2 overlapping the second non-folding area NFA2 (see FIG. 6), and the folding part FM overlapping the folding area FA (see FIG. 6). In a state in which the base substrate GL is unfolded, the first non-folding part FG1 and the second non-folding part FG2 may be spaced apart from each other in the first direction DR1 with the folding part FM interposed therebetween. The base substrate GL may include glass.

In an embodiment, the film layer CL may be disposed on the lower surface G-B of the base substrate GL and may be attached to the lower surface G-B of the base substrate GL through a separate adhesive or may be directly coated on the lower surface G-B of the base substrate GL.

In an embodiment, the first etching jig EJ1 and the second etching jig EJ2 may be arranged on the film layer CL. In more detail, the first etching jig EJ1 and the second etching jig EJ2 may be spaced apart from each other in the first direction DR1 with the folding area FA interposed therebetween, the first etching jig EJ1 may be disposed on the film layer CL overlapping the first non-folding area NFA1, and the second etching jig EJ2 may be disposed on the film layer CL overlapping the second non-folding area NFA2.

In an embodiment, a process of etching the upper surface G-U of the base substrate GL overlapping the folding area FA in a state in which the window assembly GA is disposed on the upper surface G-U of the base substrate GL and the shape of the base substrate GL is deformed based on an imaginary axis extending in the second direction DR2 may be performed. According to an embodiment, a state in which the shape of the base substrate GL is deformed may mean a state in which the base substrate GL is folded or bent, and the invention is not limited to an embodiment. In a state in which the window assembly GA is folded, the upper surfaces G-U of the base substrate GL may face each other and may be exposed from the film layer CL. Thus, during the etching process, an etchant may be in contact with the upper surface G-U of the base substrate GL. Further, as the film layer CL is disposed on the lower surface G-B of the base substrate GL, the etchant may not be in contact with the lower surface G-B of the base substrate GL during the etching process.

The method of manufacturing the window, according to an embodiment, may include an operation of providing the window assembly GA, an operation of immersing the folding part FM of the window assembly GA in the etchant, and an operation of exposing the window assembly GA from the etchant. According to an embodiment, the upper surfaces G-U of the base substrate GL may face each other in a state in which the window assembly GA is folded and may be in direct contact with the etchant. Further, a width (separation distance) of the first etching jig EJ1 and the second etching jig EJ2 in a folded state may be in a range of about 5 mm to about 50 mm.

According to the method of manufacturing the window, according to an embodiment, the flat portion CM, the inclined portion SG1, and the inclined portion SG2 of the folding part FM included in the window described in FIGS. 6 to 10 may be formed by the above-described etching process. Hereinafter, the method for manufacturing the window in which the etching process is performed in different manners will be described through FIGS. 12A to 13B.

Referring to FIGS. 12A and 12B, in the method for manufacturing the window, according to an embodiment, the operation of immersing the folding part FM of the window assembly GA into the etchant and the operation of exposing the window assembly GA from the etchant may be performed by raising and lowering the window assembly GA itself in the third direction DR3.

As illustrated in FIG. 12A, in the operation of immersing the folding part FM of the window assembly GA into the etchant, the window assembly GA itself may be lowered into a chamber CH including the etchant EL. In this case, a height TH by which the folding part FM is immersed in the etchant EL may be about 1 mm to about 20 mm.

As illustrated in FIG. 12B, in the operation of exposing the window assembly GA from the etchant, the window assembly GA itself may be raised to the outside of the chamber CH including the etchant EL.

In an embodiment, the folding part FM may be etched while a speed at which the window assembly GA is raised is maintained constant or may be etched while the window assembly is raised to the outside of the chamber CH by two stages at different speeds and is maintained.

In a first process method, when the speed at which the window assembly GA is raised is constant, an etching speed in the folding part FM is constant, and thus the inclined portion SG1 and the inclined portion SG2 formed in the folding part FM may have a linear shape as described in FIG. 6. In this case, the raising speed of the window assembly GA may be in a range of about 0.2 mm/min to about 0.6 mm/min.

In a second process method, the raising speed of the window assembly GA may be divided into two stages. In a first stage, the folding part FM may be raised at a first speed, and in a second stage, the window assembly GA may be raised at a second speed different from the first speed.

When the window assembly GA is raised at different speeds, the inclined portion SG1 and the inclined portion SG2 formed in the folding part FM may have a curved shape as described in FIG. 7.

According to an embodiment, the first speed may be faster than the second speed. The first speed may be in a range of about 0.4 mm/min to about 0.9 mm/min, and the second speed may be in a range of about 0.2 mm/min to about 0.6 mm/min.

When the window assembly GA is raised at a low speed, the inclined portions may have a more gentle curvature as compared to a case in which the window assembly GA is raised at a high speed. Referring to FIG. 7, one end of the inclined portion SG1 and the inclined portion SG2 adjacent to the first non-folding part FG1 and the second non-folding part FG2 are raised at the first speed, and the other ends of the inclined portion SG1 and the inclined portion SG2 adjacent to the flat portion CM are raised at the first speed and then raised at the second speed. Thus, the one ends and the other ends of the inclined portion SG1 and the inclined portion SG2 may have different curvatures.

According to an embodiment, as a more gentle curve is formed in a portion adjacent to the folding part FM, a stress applied between the folding part FM and the inclined portion SG1 and the inclined portion SG2 during a folding operation may be reduced. Accordingly, the method for manufacturing the window having improved folding characteristics may be provided.

As illustrated in FIG. 13A, in the operation of immersing the folding part FM of the window assembly GA in the etchant, in a state in which the window assembly GA is fixed to an inside of the chamber CH, the etchant EL may be introduced into the chamber CH, and the folding part FM may be immersed in the etchant. In this case, the height TH by which the folding part FM is immersed in the etchant EL may be about 1 mm to about 20 mm.

In an embodiment, the etchant EL may be introduced into the chamber CH or discharged to the outside of the chamber CH through a pipe SL connected to the chamber CH. As illustrated in FIG. 13B, in the operation of exposing the window assembly GA from the etchant, in a state in which the window assembly GA is fixed to the inside of the chamber CH, the etchant EL may be discharged to the outside of the chamber CH, and the folding part FM may be exposed from the etchant EL.

In an embodiment, the folding part FM may be etched while a speed at which the etchant EL is introduced/discharged is maintained constant or the folding part FM may be etched by introducing/discharging the etchant EL in two stages at different speeds.

In the first process method, when the etchant EL is discharged to the outside of the chamber CH at a constant speed, a speed at which the folding part FM may be etched is constant, and thus the inclined portion SG1 and the inclined portion SG2 formed at the folding part FM may have a linear shape as described in FIG. 6.

In the second process method, when the etchant EL is discharged to the outside of the chamber CH at different speeds in two stages, the folding part FM may be formed to have different etching ratios in areas, and thus the inclined portion SG1 and the inclined portion SG2 formed in the folding part FM may have a curved shape as described in FIG. 7. In the first stage, the etchant EL may be discharged to the outside of the chamber CH at the first speed, and in the second stage, the etchant EL may be discharged to the outside of the chamber CH at the second speed different from the first speed. The first speed may be faster than the second speed.

In an embodiment, when the etchant EL is discharged to the outside of the chamber CH at a slow speed, the inclined portion may have a gentler curve as compared to a case in which the etchant EL is discharged to the outside of the chamber CH at a fast speed.

According to an embodiment, as the more gentle curve is formed in the portion adjacent to the folding part FM, the stress applied between the folding part FM and the inclined portion SG1 and the inclined portion SG2 during the folding operation may be reduced. Accordingly, the method for manufacturing the window having improved folding characteristics may be provided.

According to an embodiment, as a portion of a base substrate overlapping a folding area of a window includes a recessed folding part, cracks may be prevented from occurring in the window during a folding operation of the display device. Accordingly, a display device including a window having improved folding characteristics and a method of manufacturing a window may be provided.

Although the description has been made above with reference to embodiments, it may be understood that those skilled in the art or those having ordinary knowledge in the art may variously modify and change the invention without departing from the spirit and technical scope of the invention.

Thus, the technical scope of the invention is not limited to the detailed description of embodiments disclosed herein.

What is claimed is:

1. A method of manufacturing a window, the method comprising:
providing a window assembly including a base substrate divided into a folding part folded about a folding axis extending in one direction, and non-folding parts spaced apart from each other with the folding part interposed therebetween and including glass, a coating layer disposed on a first surface of the base substrate, and etching jigs overlapping the non-folding parts and arranged in the coating layer;
immersing the folding part in an etchant contained in a chamber; and
exposing the folding part from the etchant,
wherein second surfaces that are disposed opposite to the first surface face each other in a folded state and are in direct contact with the etchant.

2. The method of claim 1, wherein after the exposing of the folding part of the window assembly from the etchant, the folding part has a flat portion and inclined portions that are spaced apart from each other with the flat portion interposed therebetween and inclined in a direction from the non-folding parts toward the flat portion.

3. The method of claim 2, wherein, on a cross section, the inclined portions have a linear shape.

4. The method of claim 3, wherein a thickness of the non-folding parts is in a range of about 50 μm to about 500 μm, and
wherein a thickness of the flat portion is in a range of about 20 μm to about 100 μm.

5. The method of claim 3, wherein a width of the flat portion is in a range of about 5 mm to about 50 mm, and
wherein a width of each of the inclined portions is in a range of about 1 mm to about 20 mm.

6. The method of claim 3, wherein, in a state in which the folding part is unfolded, an angle between an extension line extending from the flat portion and the inclined portion is in a range of about 0.01 degrees to about 15 degrees.

7. The method of claim 3, wherein, in the immersing of the folding part of the window assembly in the etchant, the window assembly is lowered into the chamber, and
wherein, in the exposing of the folding part of the window assembly from the etchant, the window assembly is raised to an outside of the chamber.

8. The method of claim 3, wherein, in the immersing of the folding part of the window assembly in the etchant, in a state in which the window assembly is fixed to an inside of a chamber, the etchant is introduced into the chamber, and the folding part is immersed in the etchant, and
wherein, in the exposing of the folding part of the window assembly from the etchant, in a state in which the window assembly is fixed to the inside of the chamber, the etchant is discharged to an outside of the chamber, and the folding part is exposed from the etchant.

9. The method of claim 2, wherein, on a cross section, one end and the other end of each of the inclined portions has a predetermined curvature.

10. The method of claim 9, wherein a thickness of the non-folding parts is in a range of about 30 μm to about 400 μm, and
wherein a thickness of the flat portion is in a range of about 10 μm to about 100 μm.

11. The method of claim 9, wherein a width of the flat portion is in a range of about 5 mm to about 50 mm, and
a width of each of the inclined portions is in a range of about 1 mm to about 20 mm.

12. The method of claim 9, wherein, in a state in which the folding part is unfolded, an angle between an extension line extending from the flat portion and the inclined portion is in a range of about 0.01 degrees to about 15 degrees.

13. The method of claim 9, wherein, in the immersing of the folding part of the window assembly in the etchant, the window assembly is lowered to an inside of the chamber, and
wherein, in the exposing of the folding part of the window assembly from the etchant, the window assembly is raised to an outside of the chamber.

14. The method of claim 13, wherein, in the exposing of the folding part of the window assembly from the etchant, the window assembly is raised by a first operation having a first speed and a second operation having a second speed different from the first speed.

15. The method of claim 9, wherein, in the immersing of the folding part of the window assembly in the etchant, in a state in which the window assembly is fixed to an inside of a chamber, the etchant is introduced into the chamber, and the folding part is immersed in the etchant, and
wherein, in the exposing of the folding part of the window assembly from the etchant, in a state in which the window assembly is fixed to the inside of the chamber, the etchant is exposed to an outside of the chamber, and the folding part is exposed from the etchant.

16. The method of claim 9, wherein discharging of the etchant to an outside of a chamber includes a first operation of discharging the etchant at a first speed and a second operation of discharging the etchant at a second speed different from the first speed.

17. The method of claim 1, wherein a width between the etching jigs in an intersection direction intersecting the one direction is in a range of about 5 mm to about 50 mm.

18. The method of claim 1, wherein, in the immersing of the folding part of the window assembly in the etchant, a height by which the folding part is immersed in the etchant is in a range of about 1 mm to about 20 mm.

19. A display device comprising:
a display module including a folding area folded about a folding axis extending in a first direction, and non-folding areas spaced apart from each other in a second direction intersecting the first direction with the folding area interposed therebetween; and
a window including a folding part overlapping the folding area and non-folding parts overlapping the non-folding areas and disposed on the display module,
wherein the folding part includes a flat portion having a thickness smaller than a thickness of the non-folding parts and linear inclined portions arranged between the non-folding parts and the folding part and inclined at a predetermined angle,
wherein a thickness of each of the non-folding parts is in a range of about 50 μm to about 500 μm,
wherein a thickness of the flat portion is in a range of about 20 μm to about 100 μm,
wherein a width of the flat portion in the second direction is in a range of about 5 mm to about 50 mm,
wherein a width of each of the inclined portions is in a range of about 1 mm to about 20 mm, and
wherein, in a state in which the folding part is unfolded, an angle between an extension line extending from the flat portion and the inclined portions is in a range of about 0.01 degrees to about 15 degrees.

20. An electronic device comprising:
a display device, wherein the display device includes,
a display module including a folding area folded about a folding axis extending in a first direction and non-folding areas spaced apart from each other in a second direction intersecting the first direction with the folding area interposed therebetween; and
a window including a folding part overlapping the folding area and non-folding parts overlapping the non-folding areas and disposed on the display module,
wherein the folding part includes a flat portion having a thickness smaller than a thickness of the non-folding parts and inclined portions each of which one end connected to the non-folding parts and the other end connected to the flat portion are curved at a predetermined curvature,
wherein a thickness of each of the non-folding parts is in a range of about 30 μm to about 400 μm,
wherein a thickness of the flat portion is in a range of about 10 μm to about 100 μm,
wherein a width of the flat portion in the second direction is in a range of about 5 mm to about 50 nm,
wherein a width of each of the inclined portions is in a range of about 1 mm to about 20 mm, and
wherein, in a state in which the folding part is unfolded, an angle between an extension line extending from the flat portion and the inclined portions is in a range of about 0.01 degrees to about 15 degrees.
